(19) United States
(12) Patent Application Publication
(10) Pub. No.: US 2006/0212470 A1
(43) Pub. Date: Sep. 21, 2006

(54) Information organization using formal concept analysis

(75) Inventor: Guo-Qiang Zhang, Orange Village, OH (US)

Correspondence Address: PEARNE & GORDON LLP, 1801 EAST 9TH STREET, SUITE 1200, CLEVELAND, OH, 44114-3108, US

(73) Assignee: Case Western Reserve University

(21) Appl. No.: 11/084,990

(22) Filed: Mar. 21, 2005

(51) Int. Cl. G06F 7/00

(52) U.S. Cl. 707/102

(57) ABSTRACT

A method for organizing information includes identifying objects and attributes of the information; determining a context from the objects and attributes; constructing a lattice according to said context; and organizing the information according to the lattice.

### BACKGROUND OF THE INVENTION

The present invention is related to the organization of information and, in particular, to the use of formal concept analysis to organize the information.

Formal concept analysis (FCA) is a mathematical tool for finding conceptual structures in data sets. A description of the mathematical basis of the technique can be found in Bernhard Ganter and Rudolph Wille, Formal Concept Analysis: Mathematical Foundations, Springer, Berlin, 1999, which is incorporated herein by reference.

In general, FCA involves the identification of objects and attributes in the data sets. From these objects and attributes a context is determined. The context is then used to construct a lattice. While the lattice may provide useful insights to the mathematically sophisticated, it is of little use to the average individual, particularly once its size exceeds that of simple examples.

### SUMMARY OF THE INVENTION

A method for organizing information includes identifying objects and attributes of the information; determining a context from the objects and attributes; constructing a lattice according to said context; and organizing the information according to the lattice.

### BRIEF DESCRIPTION OF THE DRAWINGS

FIG. 1, is an exemplary context shown in the form of a table.

FIG. 2, is an exemplary lattice diagram constructed from the context of FIG. 1.

FIG. 3 is an intermediate table useful in illustrating the construction of the lattice of FIG. 2 from the context of FIG. 1

FIG. 4 is an exemplary table of objects.

FIG. 5 is an exemplary table of attributes.

FIG. 6 is an exemplary context in the form of a table based on FIGS. 4 and 5.

FIG. 7 is an exemplary lattice diagram constructed from the context of FIG. 6. The node labels are omitted to enhance readability.

FIG. 8 is a block diagram of a computer according to the invention.

### DESCRIPTION OF THE PREFERRED EMBODIMENTS

As an introductory example, consider a collection of animals: lion, finch, eagle, hare, ostrich. These animals may be considered the objects of interest.

A set of attributes of interest may then be identified, for example: predator, flying, bird and mammal.

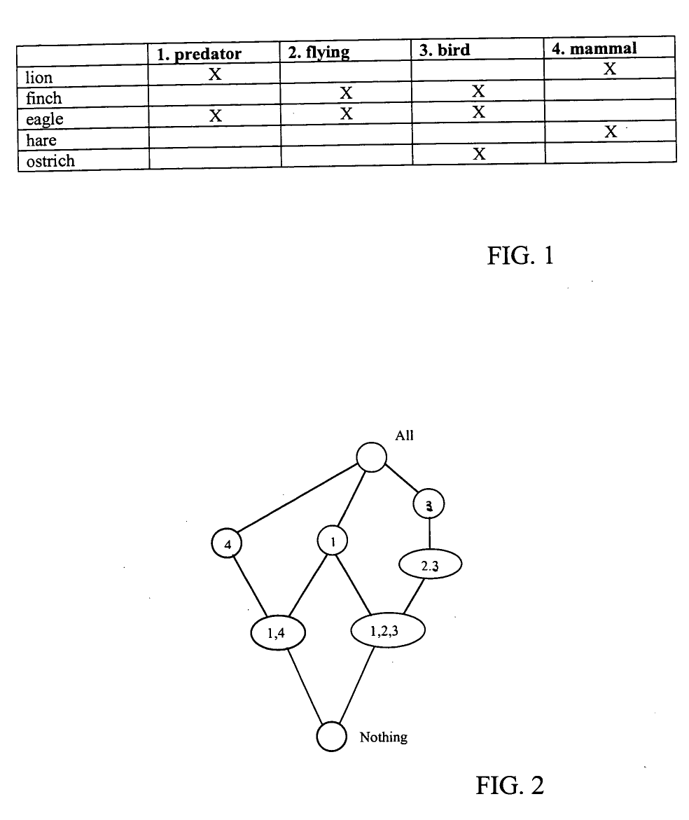

Referring to FIG. 1, a context may then be determined, represented here as a table with rows labeled by objects and columns labeled by attributes. The context indicates the relationships between the objects and the attributes, in this case the “x”s indicating that an object possesses the attribute.

From the context, a lattice can be constructed, represented visually here by the lattice diagram of FIG. 2.

A lattice always starts on a common node and ends on a common node, for example, the nodes all and nothing. This is because these nodes correspond to none of the pairs of the context and all of the pairs of the context, respectively.

The lattice of a context is typically not unique. Different choices of ordering or methods of generation result in different structures, but they are all mathematically equivalent.

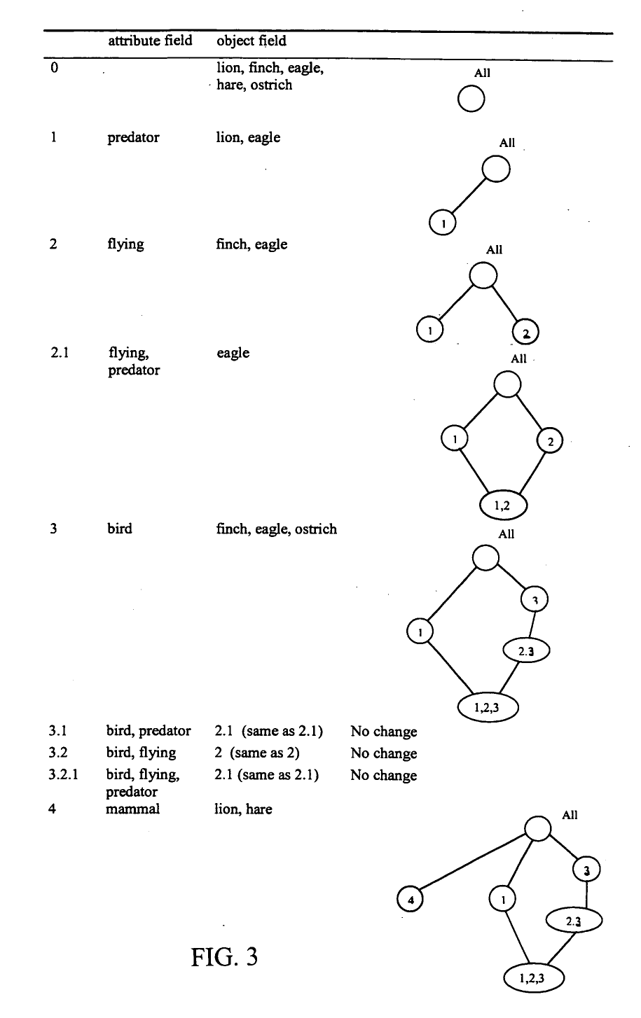

For example, to create the lattice of FIG. 2, the following steps are taken as shown in FIG. 3:

The first row, labeled 0, contains all the objects and any attributes shared by all the objects (this corresponds to a full column). Since no attributes are shared by all objects, the attributes part of the first row is empty.

Each additional row is then added according to this procedure: (a) insert a row with the next attribute and the corresponding objects by looking at FIG. 1—this row is called a primary row; and (b) for each previous row, adjoining the attributes to the primary row and extracting common objects from the concerned rows. If no new object row is generated, label the objects by pointing to the row label with the same object collection. A line drawn between an upper node and a lower node represents a sub-collection of objects.

Row 1 is generated by adjoining the attribute predator, resulting in a sub-collection of predators among all objects. This is drawn by a line between node all and node 1.

Row 2 is generated by adjoining the flying attribute, consisting of a distinct collection of objects.

Row 2.1 represents flying-predators, a new sub-collection of objects which are under both the flying objects and the predators.

In row 3, the bird category is not simply inserted below either node 1 or node 2, because in this small collection of animals, all birds fly. Therefore, flying objects is a sub-collection of birds, moving node 3 up in the diagram above node 2.

If no new object-collection is generated by combining the next attributes, then the diagram does not change. This happens in rows 3.1, 3.2, 3.2.1.

This procedure is repeated until all the attributes are considered, as seen in rows 4 through 4.3.2.1. resulting in the lattice of FIG. 2.

The combination of some attribute set may result in the empty collection—such as flying mammal, and this is when the bottom is reached, or the least collection. It is labeled by “nothing”, but this is just a name for the least node; it may actually contain objects with all the attributes under consideration.

Fortunately, algorithms suitable for computers exist for constructing lattices from contexts, as in most useful situations a manual process will quickly become unwieldy. For example, C. Lindig. Fast Concept Analysis, In Gerhard Stumme (editor), Working with Conceptual Structures—Contributions to International Conference on Conceptual Structures, 2000, Shaker Velag, Aachen, Germany, pp. 152-161, 2000 and B. Ganter and S. O. Kuznetsov. Stepwise construction of the Deedkind-MacNeille completion. In Proc. 6^{th} International Conference on Conceptual Structures, Montpellier, pp. 295-302, 1998 set forth methods for constructing lattices by computer, and are incorporated herein by reference.

To organize information using FCA one starts with identifying the objects and attributes. The objects may be, for example, a collection of web pages, computer files, messages, documents, or similar informational objects.

Identifying attributes for the objects can be done by a variety of methods, for example, manually, by computer extraction of keywords, word lists associated with a field or topic, or even random selections that are then judged iteratively on the basis of their performance.

Once the objects and attributes are identified, the context is determined. While it may be done manually, a computer program can quickly search for the attributes in each object and generate the context based on which attributes match which objects.

The lattice is then constructed from the context. This is preferably done using a computer program as discussed above.

The nodes of the lattice may be labeled heuristically if desired, but it is typically useful to label them with either a corresponding attribute (or object).

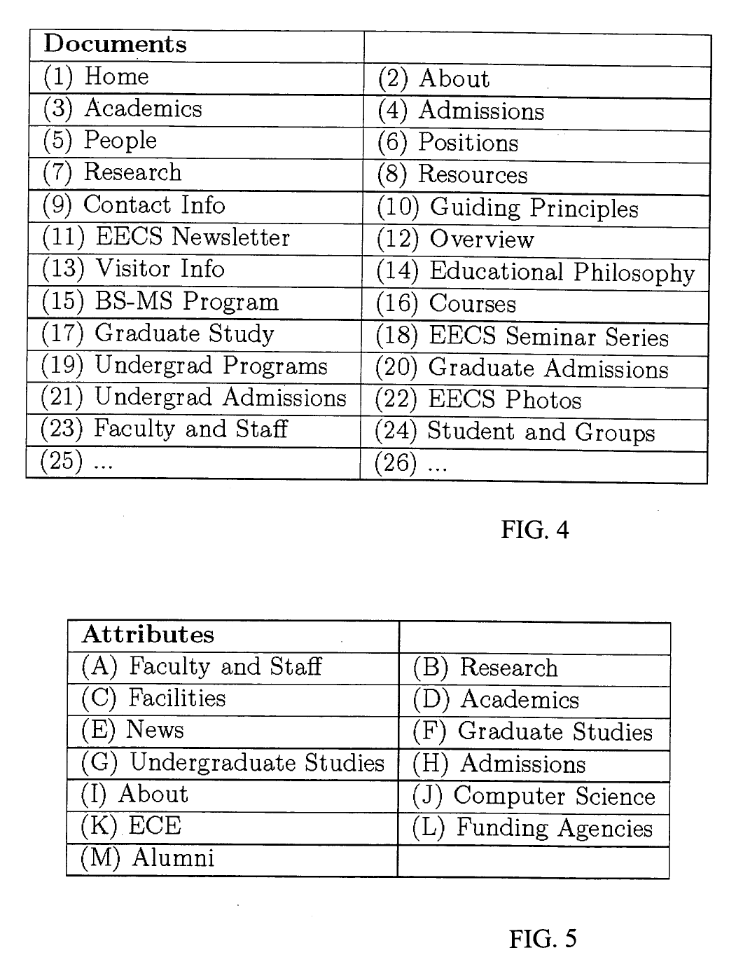

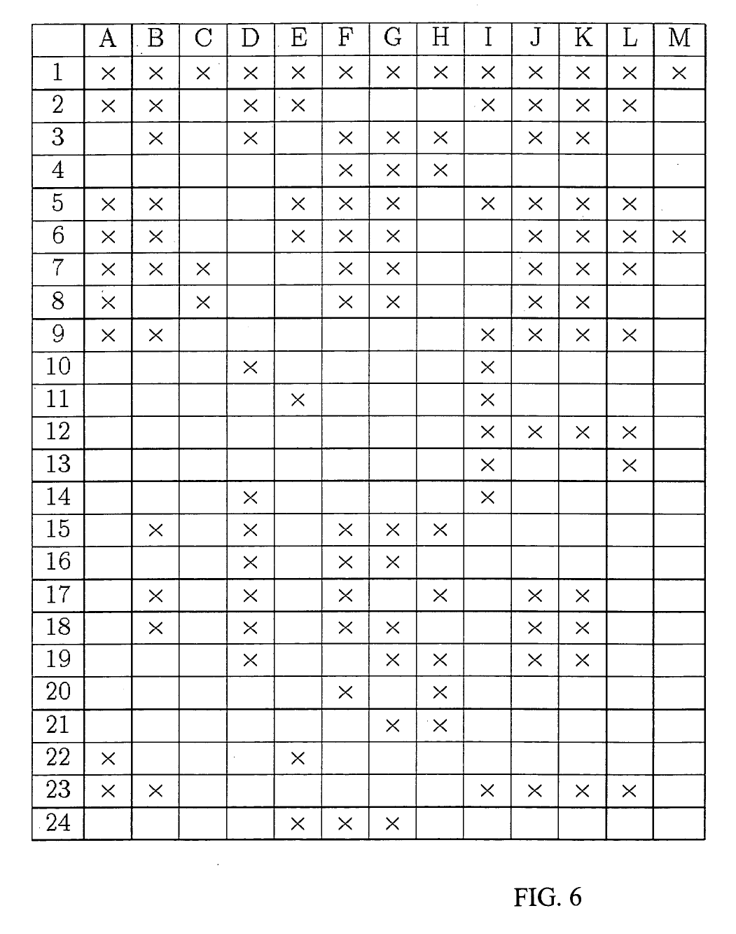

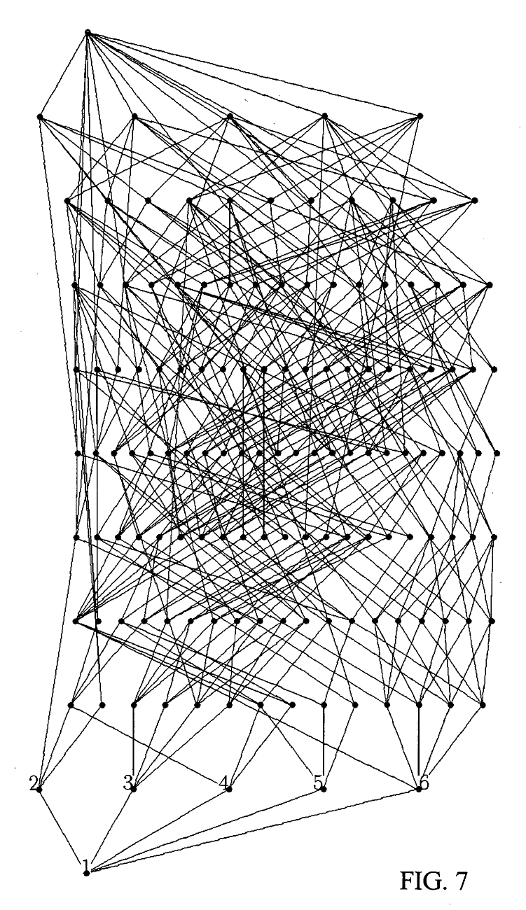

As an example, FIG. 4 shows a list of possible web pages for a university web site and FIG. 5 shows a list of possible attributes. FIG. 6 shows a context determined from the objects and attributes of FIGS. 4 and 5. FIG. 7 is a lattice constructed from the context of FIG. 5.

As can be readily seen, FIG. 7 is exceedingly complex in appearance and unlikely to provide useful information to the average person. However, the lattice can be used in organizing the information in a very useful manner.

To organize the information according to the lattice, the node labels are used to establish a hierarchy of more conventional structures. For example, the node labels (e.g., top to bottom) can be used as a basis for a hierarchy of menus for the web pages of FIG. 4. The node labels (ignoring the first node which is always empty) at the first level are the initial menu choices. The next submenu then uses the node labels at the next lower sublevel that are under a corresponding higher node. This process could continue all the way down until each object was the only choice on the last submenu, but in the case of a web menu system this is probably excessive and the process would be stopped at some convenient level, for example, at a depth of four menus.

A small portion of the web menu resulting from the lattice of FIG. 7 follows. This menu was produced with little or no human intervention.

Academics

BS-MS Program
BS-MS Admission
Graduate Study
EECS Seminar Series
Undergraduate program

Graduate Study
PhD Program
BS-MS Program
EECS Seminar Series

EECS Seminar Series

Undergraduate Programs
BS-MS Program
EECS Seminar Series
   People

About and People
EECS Newsletters
Faculty Positions
Contact Info; Faculty, Staff, Student Job Board

People and Positions
Faculty Positions
Research and Staff Positions
Student and Groups; Student Job Board; Potluck
Photos; Internal Job Postings; External Job Postings

Fac/Staff List

Positions

People and Positions
Faculty Positions
Research and Staff Positions
Student and Groups; Student Job Board; Potluck
Photos; Internal Job Postings; External Job Postings

Faculty Positions
Nord Professorship
ECE Faculty Positions

Student Job Board and External Job Posting

Research

Research Resources

Centers and Groups
Labs and Software
MFL; Amanda; Neuro; Mechanics
CCG; Pathways; Dynamics; GENIe

Faculty Research Profiles and Fac/Staff List

Presently, web menus are typically chosen at the whim of the webmaster. The present invention allows a largely automated and mathematically rigorous design to be employed instead.

Similarly, computer files are typically stored in a tree-like directory hierarchy. The present invention can be used to create meaningful directory structure (real or virtual) where the subdirectories of files are organized and labeled according to the lattice.

E-mail messages or messages on a computer message board can also be organized by this invention, or for that matter documents in general. In general, the invention can be used to organize any collection of information.

The invention has another exceptionally important and useful aspect that has not been discussed yet. Referring to FIG. 7, it can be noted that, in general, the lattices of the invention are not trees, that is, a node can be linked to more than one higher node. This means that an object that reasonably could be at the end of more than one conventional tree structure, can and will be found in multiple locations in the present invention. This will occur automatically as part of the process, rather than not at all as in a binary tree or artificially based on some ad hoc intervention.

The invention provides users with structures that casually appear to have the familiar tree-look that they are used to, while providing a much more rich and robust organization of the information.

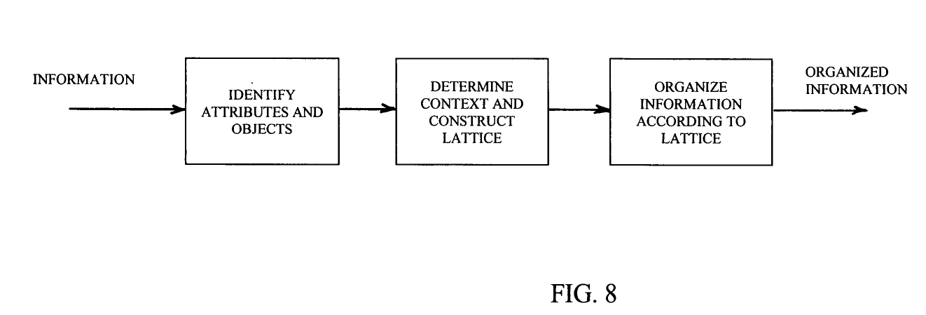

The invention can be conveniently practiced manually or preferably on a computer as shown in FIG. 8. A computer or other data processing machine programmed to perform the steps of the invention or a data storage device having a machine-readable medium containing machine instructions to perform the steps of the invention are also embodiments of the invention.

It should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

What is claimed is:

1. A method for organizing information, said method comprising:
identifying objects and attributes of the information;
determining a context from the objects and attributes;
constructing a lattice according to said context; and
organizing the information according to the lattice.

2. A method according to claim 1, wherein said information is a collection of computer files.

3. A method according to claim 1, wherein said information is a collection of web pages.

4. A method according to claim 1, wherein said information is a collection of messages.

5. A method according to claim 1, wherein said information is a collection of documents.

6. An apparatus for organizing information, said apparatus comprising:
a data processing machine programed for:
identifying objects and attributes of the information;
determining a context from the objects and attributes;
constructing a lattice according to said context; and
organizing the information according to the lattice.

7. An apparatus according to claim 6, wherein said information is a collection of computer files.

8. An apparatus according to claim 6, wherein said information is a collection of web pages.

9. An apparatus according to claim 6, wherein said information is a collection of messages.

10. An apparatus according to claim 6, wherein said information is a collection of documents.

11. A data storage device, said device comprising:
a machine-readable medium, said medium containing machine instructions for:
identifying objects and attributes of the information;
determining a context from the objects and attributes;
constructing a lattice according to said context; and
organizing the information according to the lattice.

12. A device according to claim 11, wherein said information is a collection of computer files.

13. A device according to claim 11, wherein said information is a collection of web pages.

14. A device according to claim 11, wherein said information is a collection of messages.

15. A device according to claim 11, wherein said information is a collection of documents.
